(19) United States
(12) Patent Application Publication
(10) Pub. No.: US 2013/0002938 A1
(43) Pub. Date: Jan. 3, 2013

(54) LENS ASSEMBLY AND CAMERA MODULE HAVING THE SAME

(75) Inventor: Duck-Hun KIM, Suwon-si (KR)

(73) Assignee: SAMSUNG ELECTRO-MECHANICS CO., LTD.

(21) Appl. No.: 13/538,188

(22) Filed: Jun. 29, 2012

(30) Foreign Application Priority Data
Jun. 30, 2011 (KR) 10-2011-0064782

(51) Int. Cl. H04N 5/225; G02B 9/04

(52) U.S. Cl. 348/360; 359/793; 359/356; 348/E05.028

(57) ABSTRACT

The present invention discloses a lens assembly and a camera module having the lens assembly. An aspect of the present invention provides a lens assembly that can include: a barrel arranged having a space inside thereof; a first lens accommodated in the space; a second lens stacked over the first lens and arranged to be separated from the first lens; and a cap installed over the barrel and configured to provide a load to support the second lens to the barrel.

### CROSS-REFERENCE TO RELATED APPLICATIONS

This application claims the benefit of Korean Patent Application No. 10-2011-0064782, filed with the Korean Intellectual Property Office on Jun. 30, 2011, the disclosure of which is incorporated herein by reference in its entirety.

### BACKGROUND

1. Technical Field

The present invention relates to a lens assembly and a camera module having the lens assembly.

2. Background Art

With the advancement of automobile manufacturing technologies, a camera module is installed in the rear side and/or at an arbitrary location of a motor vehicle to obtain a rear view through images taken by the camera module, in order to improve the convenience of driving and parking.

The camera module installed in the car can be constituted with lenses, a barrel, a housing, an image sensor and a printed circuit board. The lenses collect an optical image of an object, and the collected optical image is irradiated to the image sensor, which then converts and outputs the irradiated optical image to electrical signals.

While a cap has been used in the conventional technology to prevent movement of the lenses stacked in the barrel, the vertically downward load of the cap could cause a problem of cracking components inside the barrel.

That is, in case thermal expansion occurs to the IR filter, lenses and the like components, due to surrounding conditions, while the vertically downward load is applied by the cap, crack can occur in structurally fragile portions of these components.

### SUMMARY

Some embodiments of the present invention provide a lens assembly that can prevent a crack from occurring in internal components thereof and a camera module having such a lens assembly.

An aspect of the present invention features a lens assembly that can include: a barrel arranged having a space inside thereof; a first lens accommodated in the space; a second lens stacked over the first lens and arranged to be separated from the first lens;

and a cap installed over the barrel and configured to provide a load to support the second lens to the barrel.

A support protrusion for supporting the second lens can be formed at an upper portion of the barrel.

The support protrusion can have an annular structure that is extended in a circumferential direction of the second lens.

The lens assembly can also include a shock-absorbing member interposed in between the first lens and the second lens.

The shock-absorbing member can have an annular structure that is extended in a circumferential direction of the second lens.

The lens assembly can also include a sealing member interposed in between the second lens and the barrel in order to prevent moisture from permeating from an outside.

The barrel can have a bonding groove, which is for fixing the first lens being injected into the bonding groove, formed therein.

The lens assembly can also include an infrared (IR) filter accommodated in the space.

The first lens can be stacked above the IR filter.

The cap can cover a brim of the second lens to apply the load downwardly to the brim of the second lens.

A protruded part, which is protruded toward the space in order to support the first lens, can be formed in a lower part of the barrel.

The first lens can be provided in plurality, and the plurality of first lenses can be stacked with one another.

The first lens can be a plastic injection mold.

The second lens can be made of a material comprising glass.

Another aspect of the present invention features a camera module that can include: a printed circuit board having an image sensor installed therein; and a lens assembly arranged on the image sensor, and the lens assembly can include: a barrel arranged having a space inside thereof; a first lens accommodated in the space; a second lens stacked over the first lens and arranged to be separated from the first lens; and a cap installed over the barrel and configured to provide a load to support the second lens to the barrel.

A support protrusion for supporting the second lens can be formed at an upper portion of the barrel.

The support protrusion can have an annular structure that is extended in a circumferential direction of the second lens.

The lens assembly can also include a shock-absorbing member interposed in between the first lens and the second lens.

The shock-absorbing member can have an annular structure that is extended in a circumferential direction of the second lens.

The lens assembly can also include a sealing member interposed in between the second lens and the barrel in order to prevent moisture from permeating from an outside.

The barrel can have a bonding groove, which is for fixing the first lens being injected into the bonding groove, formed therein.

The lens assembly can also include an infrared (IR) filter accommodated in the space.

The first lens can be stacked above the IR filter.

The cap can cover a brim of the second lens to apply the load downwardly to the brim of the second lens.

A protruded part, which is protruded toward the space in order to support the first lens, can be formed in a lower part of the barrel.

The first lens can be provided in plurality, and the plurality of first lenses can be stacked with one another.

The first lens can be a plastic injection mold.

The second lens can be made of a material comprising glass.

### BRIEF DESCRIPTION OF THE DRAWINGS

FIG. 1 is a cross-sectional view showing a lens assembly in accordance with an embodiment of the present invention.

FIG. 2 is an exploded view of a portion marked “A” in FIG. 1.

FIG. 3 is a cross-sectional view of a lens assembly in accordance with another embodiment of the present invention.

FIG. 4 is an exploded view of a portion marked “C” in FIG. 3.

### DETAILED DESCRIPTION OF THE INVENTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, some embodiments of a lens assembly and a camera module having the lens assembly in accordance with the present invention will be described with reference to the accompanying drawings, in which any identical or corresponding elements are assigned the same reference numerals and will not be described redundantly.

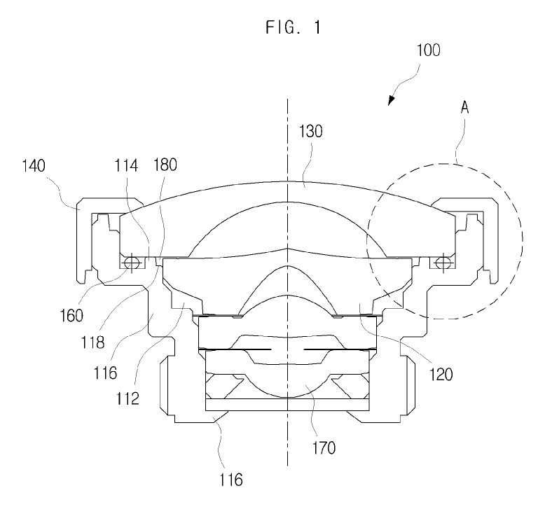

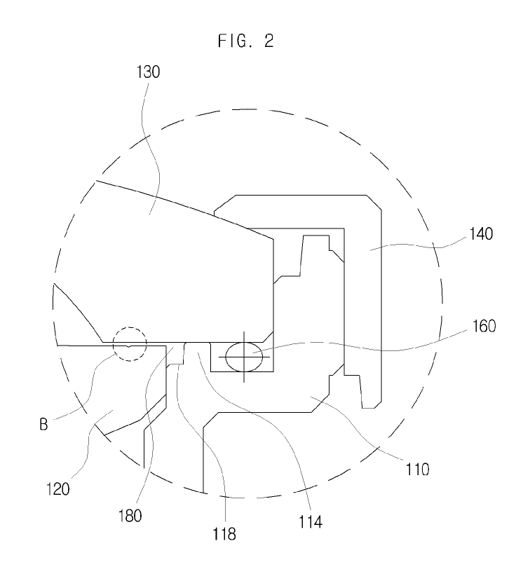

FIG. 1 is a cross-sectional view showing a lens assembly 100 in accordance with an embodiment of the present invention, and FIG. 2 is an exploded view of a portion marked “A” in FIG. 1.

According to this embodiment, as shown in FIGS. 1 and 2, the lens assembly 100 is constituted with a barrel 110, a first lens 120, a second lens 130, a cap 140, a sealing member 160 and an infrared (IR) filter 170.

According to this embodiment, by arranging the second lens 130 to be separated from the first lens 120 by a predetermined distance, crack can be effectively prevented from occurring in internal components, such as the first lens 120 and the IR filter 170, which are arranged in a space 112 of the barrel 110.

As illustrated in FIGS. 1 and 2, the cap 140 can be installed over the barrel 110 in order to prevent the second lens 130 from moving, and the cap 140 applies a vertically downward load to the second lens 130 in order to support the second lens 130.

In case thermal expansion occurs to a component inside the barrel 110 such as the first lens 120 or the IR filter 170 due to an influence such as surrounding temperature while the vertically downward load is applied by the cap 140, crack can occur in a structurally fragile portion of that component.

However, in the case of this embodiment, the crack caused by the thermal expansion of the component can be effectively prevented by separating the second lens 130 from the first lens 120.

Hereinafter, the components of the lens assembly 100 in accordance with the present embodiment will be described in more detail with reference to FIGS. 1 and 2.

As shown in FIG. 1, the barrel 110 has a hollow structure in such a way that the space 112 for mounting the first lens 120, the second lens 130 and the IR filter 170 can be provided inside the barrel 110.

The IR filter 170 can be accommodated within the space 112 of the barrel 110, as illustrated in FIG. 1. The IR filter 170 can remove unnecessary noise from an image that is inputted to the image sensor through the second lens 130 and the first lens 120.

In such a case, a protruded part 116, which is protruded toward the space 112 in order to support the IR filter 170 and the first lens 120 stacked above the IR filter, can be provided in a lower part of the barrel 110. Accordingly, after being inserted in the space 112 of the barrel 110, the IR filter 170 can be upwardly supported by the protruded part 116.

As illustrated in FIG. 1, the first lens 120 can be accommodated in the space 112 of the barrel 110 and can be stacked above the IR filter 170. The first lens 120 can be provided in plurality, which can be stacked with one another. Moreover, the first lens 120 can be a plastic injection mold.

The first lens 120 receives a photographed image and makes the received image incident upon the image sensor. The first lens 120 is not restricted by the shape or number. A plurality of first lenses 120 can be concentrically arranged. The plurality of first lenses 120 can be various combinations of convex lenses and concave lenses, and spacers can be interposed in between these lenses to control the distance between the first lenses 120.

As illustrated in FIGS. 1 and 2, the barrel 110 can have a bonding groove 118, into which adhesive 180 for fixing the first lens 120 is injected, formed therein. Specifically, the bonding groove 118 can be extended along an inner circumferential surface of the barrel 110 that is adjacent to an outer circumferential surface of the first lens 120, and by injecting the adhesive 180 into the bonding groove 118 after placing the first lens 120 in the space 112 of the barrel 110, movement of the first lens 120 and the IR filter 170 stacked beneath the first lens 120 can be effectively prevented.

As illustrated in FIGS. 1 and 2, the second lens 130 can be stacked above the first lens 120 and arranged to be separated from the first lens 120. Such a second lens 130 can be a glass lens made of glass. Since the second lens 130, as shown in a portion marked “B” in FIG. 2, can be separated from the first lens 120 by a distance of less than 0.5 mm, the internal components such as the first lens 120 and the IR filter 170 can be effectively prevented from cracking.

In such a case, as illustrated in FIGS. 1 and 2, a support protrusion 114 for supporting the second lens 130 can be formed at an upper portion of the barrel 110. Specifically, as the support protrusion 114 is protruded to be higher than a surface of the first lens 120, it is possible for the second lens 130 to maintain the separation from the first lens 120 by placing the second lens 130 on the support protrusion 114.

The support protrusion 114 can have an annular structure that is extended in a circumferential direction of the second lens 130, that is, along an inner circumferential surface of the barrel 110. Accordingly, a vertically downward load applied by the cap can be more uniformly diffused by the support protrusion 114 in the annular structure, making it possible to realize the lens assembly 100 with an improved durability.

The cap 140 can be installed on an outer circumferential surface of the barrel 110, as illustrated in FIGS. 1 and 2, to provide a load for supporting the second lens 130 to the barrel 110. More specifically, the cap 140 can cover a brim of the second lens 130 to apply the load downwardly to the brim of the second lens 130.

The cap 140 can include a coupling part, which is coupled with the outer circumferential surface of the barrel 110, and a cover, which is extended in a transverse direction from the coupling part to cover the brim of the second lens 130. The coupling part can have screw threads formed on an inner circumferential surface thereof so that the coupling part can be screw-coupled with screw grooves formed on the outer circumferential surface of the barrel 110.

The sealing member 160 can be interposed in between the second lens 130 and the barrel 110, as illustrated in FIGS. 1 and 2, to prevent moisture from permeating from an outside. Specifically, the sealing member 160 is placed on an upper portion of the barrel 110, and then the second lens 130 is placed on the support protrusion 114 of the barrel 110. Then, as the cap 140 is installed on the barrel 110 to apply the vertically downward load to the second lens 130, the sealing member 160 is compressed in between the second lens 130 and the barrel 110 to tightly seal an inside of the lens assembly from outside surroundings.

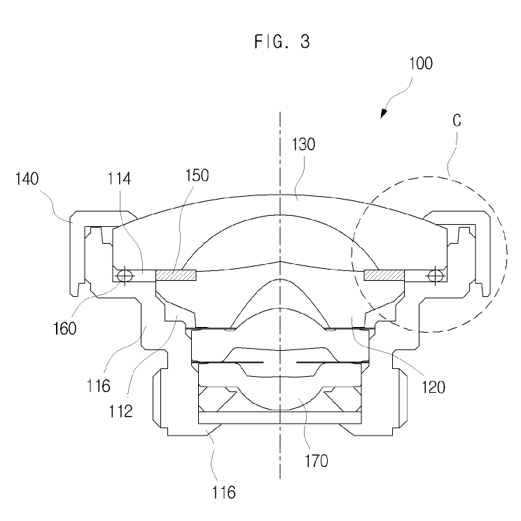

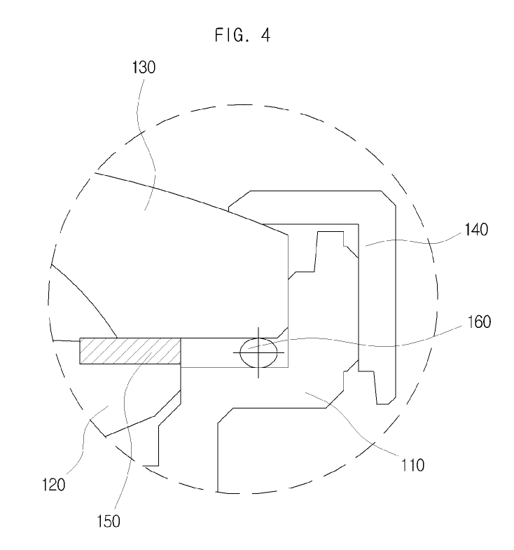

Hereinafter, a lens assembly 100 in accordance with another embodiment of the present invention will be described with reference to FIGS. 3 and 4.

FIG. 3 is a cross-sectional view of a lens assembly 100 in accordance with another embodiment of the present invention, and FIG. 4 is an exploded view of a portion marked “C” in FIG. 3.

The present embodiment is different from the earlier-described embodiment in that a shock-absorbing member 150 is interposed in between the first lens 120 and the second lens 130, and thus this difference will be mainly described below.

As illustrated in FIGS. 3 and 4, the shock-absorbing member 150 can be interposed in between the first lens 120 and the second lens 130. Specifically, the shock-absorbing member 150 can be inserted into the separated space 112 between the first lens 120 and the second lens 130, and accordingly, any crack caused by the vertically downward load of the cap 140 can be more effectively prevented.

Such a shock-absorbing member 150 can have an annular structure that is extended in the circumferential direction of the second lens 130, that is, along the inner circumferential surface of the barrel 110. Therefore, the shock-absorbing member 150 can support the second lens 130 more securely on the first lens 120, thereby more effectively preventing the crack from occurring.

Used for the shock-absorbing member 150 can be a spring, such as a leaf spring and a coil spring, an elastic material such as rubber, a synthetic fiber such as felt, and other injection molds that are capable of absorbing a shock. While, in the case of the present embodiment, the support protrusion 114 (see FIG. 1) is omitted due to the introduction of the shock-absorbing member, it is also possible to introduce the shock-absorbing member in a structure where the second lens 130 is placed on the support protrusion 114, as in the earlier-described embodiment.

Hereinafter, an embodiment of a camera module having the lens assembly 100 in accordance with the above-described embodiments will be described.

A camera module for rear viewing of a vehicle can be realized using the lens assembly 100 illustrated in FIGS. 1 to 4. Such a camera module can include a housing, a printed circuit board and the lens assembly 100.

The housing can have a hole for mounting the lens assembly 100 formed in a middle thereof, the lens assembly 100 can be arranged on an image sensor installed in the printed circuit board and mounted in the hole of the housing.

An actuator for autofocusing can be coupled inside the housing, and the lens assembly 100 mounted through the hole can be placed inside the housing. Screw grooves can be formed on an inner circumferential surface of the housing, and screw threads can be formed on an outer circumferential surface of the barrel 110 of the lens assembly 100, making it possible for the lens assembly 100 to be screw-coupled to the hole of the housing.

The printed circuit board having the image sensor installed therein can be mounted in a lower portion of the housing. The housing and the printed circuit board can be fixed with each other through an adhesive such as epoxy. The printed circuit board can have an electric circuit pattern and a plurality of electrodes and can digitally process an image signal outputted from the image sensor.

The image sensor can be a structure in which a plurality of pixels are integrated. Each of the pixels is a kind of photodetector that can convert an incident image to an electrical signal and then to data. That is, the image sensor can convert an image incident through the lens assembly 100 to electrical data, and this data can be processed in an image processor.

The image processor can be provided in a lower portion of the printed circuit board. The image processor can store, edit, transmit, restore and delete the image that is converted to the electrical signal through the image sensor.

Although some embodiments of the present invention have been described, it shall be appreciated that a large number of permutations and modifications of the present invention are possible by those who are skilled in the art to which the present invention pertains by supplementing, modifying, deleting and/or adding some elements without departing from the technical ideas and scopes of the present invention that are defined in the appended claims.

What is claimed is:

1. A lens assembly comprising:
a barrel arranged having a space inside thereof;
a first lens accommodated in the space;
a second lens stacked over the first lens and arranged to be separated from the first lens; and
a cap installed over the barrel and configured to provide a load to support the second lens to the barrel.

2. The lens assembly of claim 1, wherein a support protrusion for supporting the second lens is formed at an upper portion of the barrel.

3. The lens assembly of claim 2, wherein the support protrusion has an annular structure that is extended in a circumferential direction of the second lens.

4. The lens assembly of claim 1, further comprising a shock-absorbing member interposed in between the first lens and the second lens.

5. The lens assembly of claim 4, wherein the shock-absorbing member has an annular structure that is extended in a circumferential direction of the second lens.

6. The lens assembly of claim 1, further comprising a sealing member interposed in between the second lens and the barrel in order to prevent moisture from permeating from an outside.

7. The lens assembly of claim 1, wherein the barrel has a bonding groove formed therein, adhesive for fixing the first lens being injected into the bonding groove.

8. The lens assembly of claim 1, further comprising an infrared (IR) filter accommodated in the space.

9. The lens assembly of claim 8, wherein the first lens is stacked above the IR filter.

10. The lens assembly of claim 1, wherein the cap covers a brim of the second lens to apply the load downwardly to the brim of the second lens.

11. The lens assembly of claim 10, wherein a protruded part is formed in a lower part of the barrel, the protruded part being protruded toward the space in order to support the first lens.

12. The lens assembly of claim 1, wherein the first lens is provided in plurality, and
wherein the plurality of first lenses are stacked with one another.

13. The lens assembly of claim 1, wherein the first lens is a plastic injection mold.

14. The lens assembly of claim 1, wherein the second lens is made of a material comprising glass.

15. A camera module comprising:
a printed circuit board having an image sensor installed therein; and
a lens assembly arranged on the image sensor,
wherein the lens assembly comprises:
a barrel arranged having a space inside thereof;
a first lens accommodated in the space;
a second lens stacked over the first lens and arranged to be separated from the first lens; and
a cap installed over the barrel and configured to provide a load to support the second lens to the barrel.

16. The camera module of claim 15, wherein a support protrusion for supporting the second lens is formed at an upper portion of the barrel.

17. The camera module of claim 16, wherein the support protrusion has an annular structure that is extended in a circumferential direction of the second lens.

18. The camera module of claim 15, further comprising a shock-absorbing member interposed in between the first lens and the second lens.

19. The camera module of claim 18, wherein the shock-absorbing member has an annular structure that is extended in a circumferential direction of the second lens.

20. The camera module of claim 15, further comprising a sealing member interposed in between the second lens and the barrel in order to prevent moisture from permeating from an outside.

21. The camera module of claim 15, wherein the barrel has a bonding groove formed therein, adhesive for fixing the first lens being injected into the bonding groove.

22. The camera module of claim 15, further comprising an infrared (IR) filter accommodated in the space.

23. The camera module of claim 22, wherein the first lens is stacked above the IR filter.

24. The camera assembly of claim 15, wherein the cap covers a brim of the second lens to apply the load downwardly to the brim of the second lens.

25. The camera module of claim 24, wherein a protruded part is formed in a lower part of the barrel, the protruded part being protruded toward the space in order to support the first lens.

26. The camera module of claim 15, wherein the first lens is provided in plurality, and
wherein the plurality of first lenses are stacked with one another.

27. The camera module of claim 15, wherein the first lens is a plastic injection mold.

28. The camera module of claim 15, wherein the second lens is made of a material comprising glass.
